(19) United States
(12) Patent Application Publication
(10) Pub. No.: US 2023/0068482 A1
(43) Pub. Date: Mar. 2, 2023

(54) TIME INTERVALS AMONG MEMORY OPERATIONS OF NON-VOLATILE MEMORY

(71) Applicant: Micron Technology, Inc., Boise, ID (US)

(72) Inventors: Sheyang Ning, San Jose, CA (US); Kitae Park, Cupertino, CA (US)

(21) Appl. No.: 17/464,289

(22) Filed: Sep. 1, 2021

(51) Int. Cl. G06F 3/06

(52) U.S. Cl. CPC G06F 3/0659; G06F 3/061; G06F 3/0652; G06F 3/0679

(57) ABSTRACT

A method includes performing a first memory operation having a first type on a location of a memory component. The method further includes, responsive to receiving an access request to perform a second memory operation having a second type on the location, preventing, subsequent to completion of the first memory operation, the second memory operation from being performed for a period of time corresponding to a particular time interval associated with the first type and a second type.

### TECHNICAL FIELD

Embodiments of the disclosure relate generally to memory sub-systems, and more specifically, relate to time intervals among memory operations of non-volatile memory.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 illustrates an example timing diagram associated with time intervals among memory operations of non-volatile memory in accordance with some embodiments of the present disclosure.

FIG. 3 is a flow diagram corresponding to a method for time intervals among memory operations of non-volatile memory in accordance with some embodiments of the present disclosure.

FIG. 4 is a block diagram of an example computer system in which embodiments of the present disclosure can operate.

### DETAILED DESCRIPTION

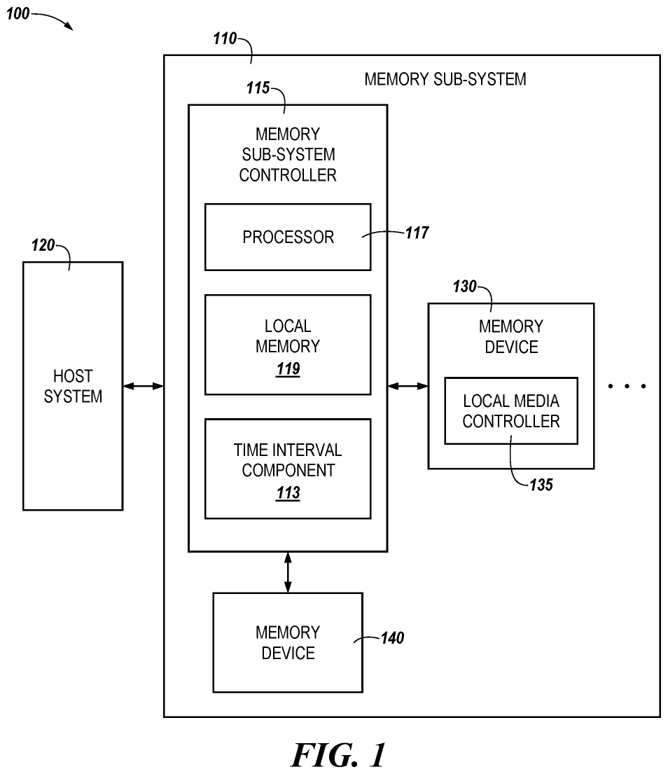

Aspects of the present disclosure are directed to time intervals among memory operations of non-volatile memory, in particular to memory sub-systems that include a time interval component to ensure a period of time corresponding to a particular time period between performance of two memory (e.g., read, write, program, and/or erase) operations. A memory sub-system can be a storage system, storage device, a memory module, or a combination of such. An example of a memory sub-system is a storage system such as a solid-state drive (SSD). Examples of storage devices and memory modules are described below in conjunction with FIG. 1, et alibi. In general, a host system can utilize a memory sub-system that includes one or more components, such as memory devices that store data. The host system can provide data to be stored at the memory sub-system and can request data to be retrieved from the memory sub-system.

A memory device can be a non-volatile memory device. One example of non-volatile memory devices is a negative-and (NAND) memory device (also known as flash technology). In a non-volatile memory device, such as a NAND memory device, programming cells can involve providing a programming signal to a group of cells (e.g., a page) to place them in target states, which correspond to respective stored data patterns. The non-volatile flash memory cells can be cells configured to store one or more (e.g., N) bits of data per cell, which can result in 2^{N} target states the memory cell can be programmable to.

A read window, which may be referred to as a read window width, refers to a distance (e.g., in voltage) between adjacent threshold voltage (Vt) distributions at a particular bit error rate (BER). A read window may also be referred to as a “valley margin” since the Vt distributions include respective peaks with the regions therebetween being referred to as valleys. A read window budget (RWB) can refer to a cumulative value of read windows for a group of programmed cells (e.g., one or more pages of cells). For example, cells configured to store three bits of data per cell may be programmed to one of eight different Vt distributions, each corresponding to a respective data state. In this example, the RWB can be the cumulative value (e.g., in voltage) of the seven read windows between the eight Vt distributions.

The RWB corresponding to a group of memory cells can vary over time due to migration of charges (e.g., positive and/or negative charges, such as holes and/or electrons) trapped (e.g., stored) in various layers of the memory cells, which can occur during stable to transient, transient to stable (S-T, T-S) transition of the memory cells. For example, electrons trapped in a conductive layer (that can be formed of polysilicon (Poly-Si)) of the memory cells can migrate to different locations subsequent to program and/or read operations. For example, electrons/holes trapped in a charge trapping layer of the memory cells can migrate to different locations (in lateral and vertical directions) subsequent to program and/or erase operations. The migrations of holes/electrons previously trapped in those layers can cause a shift and/or widening of the Vt distributions, which can further result in a reduced RWB of the group of memory cells.

The reduced RWB(s) can negatively affect the system quality of service (QoS), reliability, and/or performance. In various instances, accordingly, it can be beneficial to maintain a RWB in order to maintain a particular system characteristic (e.g., QoS, error rate, etc.) across various environmental conditions and/or user workloads. However, complex circuitry and/or mechanism that have been implemented in previous approaches in order to maintain RWB(s) above a particular level have been often costly and inefficient.

Aspects of the present disclosure address the above and other deficiencies by controlling time intervals among memory operations of non-volatile memory. A time interval between performances of two consecutive operations (e.g., program, write, read, and/or erase operations) can further affect the Vt distributions, which can be further shifted and/or widened based on when a subsequent memory operation is performed in relation to a previously performed memory operation. Simply ensuring a specified time interval between performance of two consecutive memory operation on a location can further reduce an undesired shift and/or widening of the Vt distributions. Therefore, embodiments of the present disclosure allow the memory sub-system to control when to perform a subsequent memory operation on a location of NAND memory devices in relation to a memory operation previously performed on the location. For example, a subsequent memory operation having a particular type can be prevented from being performed for a predetermined period of time corresponding to a particular time interval subsequent to performance of a previous memory operation, which can lessen the undesired shift and/or widening of the Vt distributions and reduction of the RWB(s) of the memory cells.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random access memory (SDRAM).

An example of non-volatile memory devices (e.g., memory device 130) includes a negative-and (NAND) type flash memory. Each of the memory devices 130 can include one or more arrays of memory cells. The memory cells can include single level cells (SLCs) that can store one bit per cell, multi-level cells (MLCs) that can store two bits per cell, triple level cells (TLCs) that can store three bits per cell, quad-level cells (QLCs) that can store four bits per cell, and/or penta-level cells (PLCs) that can store five bits per cell, among others. As used herein, the term multiple level cells is used to refer to cells configured to store more than one bit per cell (e.g., MLC, TLC, QLC, PLC, etc.). In some embodiments, a particular memory component can include an SLC portion, and an MLC portion, a TLC portion, a QLC portion, and/or a PLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as and NAND type memory are described, the memory device 130 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RANI (CBRAM), resistive random access memory (RRAM), oxide based RRAM (OxRAM), negative-or (NOR) flash memory, and electrically erasable programmable read-only memory (EEPROM).

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130. The memory sub-system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140.

In some embodiments, the memory device 130 includes local media controllers 135 that operate in conjunction with memory sub-system controller 115 to execute operations on one or more memory cells of the array 114 of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 can include a time interval component 113. Although not shown in FIG. 1 so as to not obfuscate the drawings, the time interval component 113 can include various circuitry to facilitate adjusting a time interval to be placed among memory operations. In some embodiments, the adjustment circuitry 113 can include special purpose circuitry in the form of an ASIC, FPGA, state machine, and/or other logic circuitry that can allow the time interval component 113 to orchestrate and/or perform operations as described herein. In some embodiments, the memory sub-system controller 115 includes at least a portion of the time interval component 113. In some embodiments, the time interval component 113 is part of the host system 120, an application, or an operating system.

Although not illustrated in FIG. 1, the time interval component 113 can further include other circuitry that can determine and/or adjust trim levels of the memory devices 130 and/or 140. As used herein, trim levels can include pulse magnitude, step size, pulse duration, program verify voltages, and/or read voltages, among other possible trim levels.

In some embodiments, the time interval component 113 can be configured to cause the memory device 130 to place a time interval between performance of at least two memory operations (e.g., erase, program, write, and/or read operations) performed and/or to be performed on a same location (e.g., a page and/or a block of memory cells) of the memory device 130 and/or adjust the time interval. The time interval placed in performing between two (e.g., consecutive) memory operations can prevent a subsequent memory operation (of two memory operations) from being performed for a period of time corresponding to the time interval subsequent to performance of a previous memory operation (of two memory operations).

The time interval component 113 can store multiple (e.g., predetermined) time intervals respectively corresponding to memory operations of particular types. For example, although embodiments are not so limited, the time interval component 113 can store a time interval corresponding to/between a program and a read operations, a time interval corresponding to/between an erase and program operations, and a time interval corresponding to/between a program and an erase operations. Memory operations can be performed with the time intervals defined/stored in the time interval component 113. In some embodiments, at least two of multiple time intervals stored in the time interval component can correspond to different periods of time. Those types of memory operations that are not defined/stored in the time interval component 113 can be performed regardless of the time intervals stored in the time interval component 113. For example, an erase operation can be performed at any time subsequent to a previous erase operation if the time interval component 113 does not define/specify a time interval between two erase operations.

In a non-limiting example, once an access request to perform a memory operation on a particular location of the memory device 130 is received at (e.g., the time interval component 113 of) the memory sub-system controller 115, the time interval component 113 can determine (e.g., select) if one of time intervals corresponds to respective types of a previous memory operation performed and/or being performed on the location and the memory operation of the received access request (e.g., subsequent memory operation). In response to one of time intervals corresponds to the respective type of the memory operations, the time interval component 113 can cause the memory device 130 to perform the subsequent memory operation based on the determined time interval. For example, the subsequent memory operation can be prevented from being performed for a period of time corresponding to the determined time interval subsequent to performance of the previous memory operation. Stated alternatively, for example, the subsequent memory operation can be allowed to be performed in response to the period of time having expired. If the time intervals stored in the time interval component 113 does not correspond to the types of the memory operations, the time interval component 113 can cause the memory device 130 independently of/regardless of the time intervals.

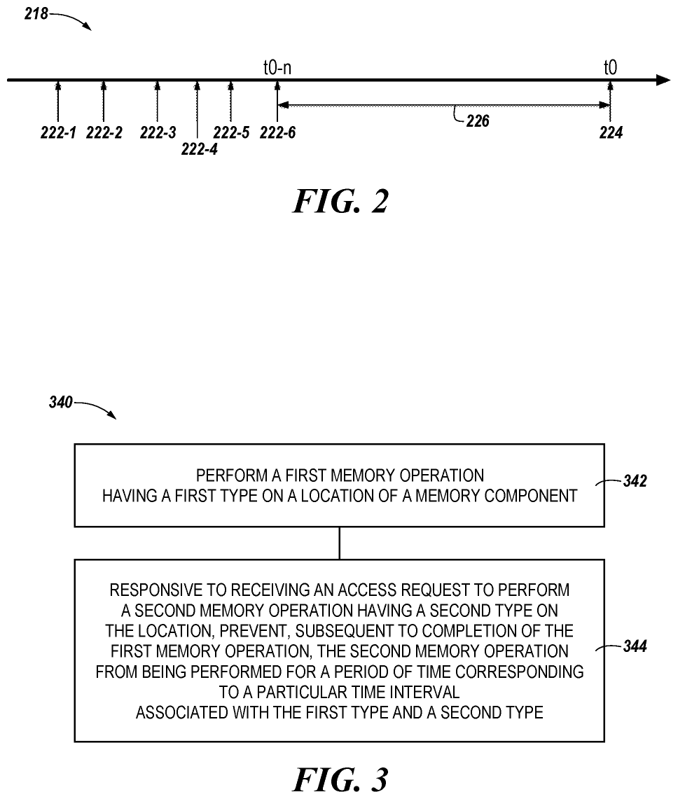

FIG. 2 illustrates an example timing diagram 218 associated with time intervals among memory operations of non-volatile memory in accordance with some embodiments of the present disclosure. For example, FIG. 2 illustrates a timing diagram associated with placing a time interval between performance of a memory operation 222-6 and a subsequent memory operation 224.

FIG. 2 illustrates a series of memory operations 222-1, . . . , 222-6 (collectively referred to as memory operations 222) performed in a sequence of 222-1, 222-2, 222-3, 222-4, 222-5, and 222-6. These memory operations 222 can have a same type. For example, the memory operations 222 can be an erase operation. FIG. 2 further illustrates a memory operation 224 performed subsequent to the memory operation 222-6. The memory operation 224 can have a different type than that of the memory operations 222, such as the memory operation 222-6. Each arrow of 222-1, . . . , 221-6 and 224 can indicate a period of time during which performance of a respective memory operation is initiated and completed. Although embodiments are not so limited, the memory operations 222 and 224 can be memory operations that are performed on a same location of a memory device (e.g., the memory device 130 illustrated in FIG. 1), such as a page and/or block of the memory device.

In some embodiments, the memory operations 222-6 and 224 can be performed with a time interval 226 placed between those. For example, subsequent to performance of the memory operation 222-6 (e.g., performed and completed at a time t0-n illustrated in FIG. 2), the memory operation 224 can be prevented from being performed for a period of time corresponding to the time interval 226. Upon expiration of the period of time corresponding to the time interval 226 (e.g., such as at a time t0 illustrated in FIG. 2) the memory operation 224 can be allowed to be performed.

In some embodiments, memory operations having a particular and same type can be performed regardless of a time interval. For example, as illustrated in FIG. 2, the memory operations 222-1, . . . , 222-6 that have a same type (e.g., an erase operation) can be performed at any time without being prevented from being performed for a period of time corresponding to a particular time interval.

FIG. 3 is a flow diagram corresponding to a method 340 for time intervals among memory operations of non-volatile memory in accordance with some embodiments of the present disclosure. The method 340 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 340 is performed by the time interval component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 342, a first memory operation having a first type can be performed on a location of a memory component (e.g., the memory device 130 illustrated in FIG. 1). At operation 344, responsive to receiving an access request to perform a second memory operation having a second type on the location, the second memory operation can be prevented, subsequent to completion of the first memory operation, from being performed for a period of time corresponding to a particular time interval associated with the first type and a second type. For example, the second memory operation can be allowed to be performed upon expiration of the period of time.

In some embodiments, the second memory operation can be allowed to be performed independently of whether the period of time has expired or not responsive to the second memory operation having the first type instead of the second type. For example, the second memory operation can be allowed to be performed within the period of time subsequent to completion of the first memory operation.

In some embodiments, the particular time interval can be one of a plurality of time intervals. In this example, when access requests to perform a plurality of memory operations on the location of the memory component are received, a respective one of the plurality of time intervals associated with each set of consecutive memory operations of the plurality of memory operations can be determined. Further, the plurality of memory operations with the determined respective one of the plurality of time intervals can be performed to prevent a subsequent one of each set of consecutive memory operations from being performed within a respective period of time corresponding to the determined respective one of the plurality of time intervals subsequent to completion of a respective memory operation of the set. In some embodiments, a set of two consecutive memory operations of the plurality of memory operations can be performed independently of the plurality of time intervals responsive to respective types of the consecutive memory operations of the set not corresponding to a respective set of types defined in association with the plurality of time intervals.

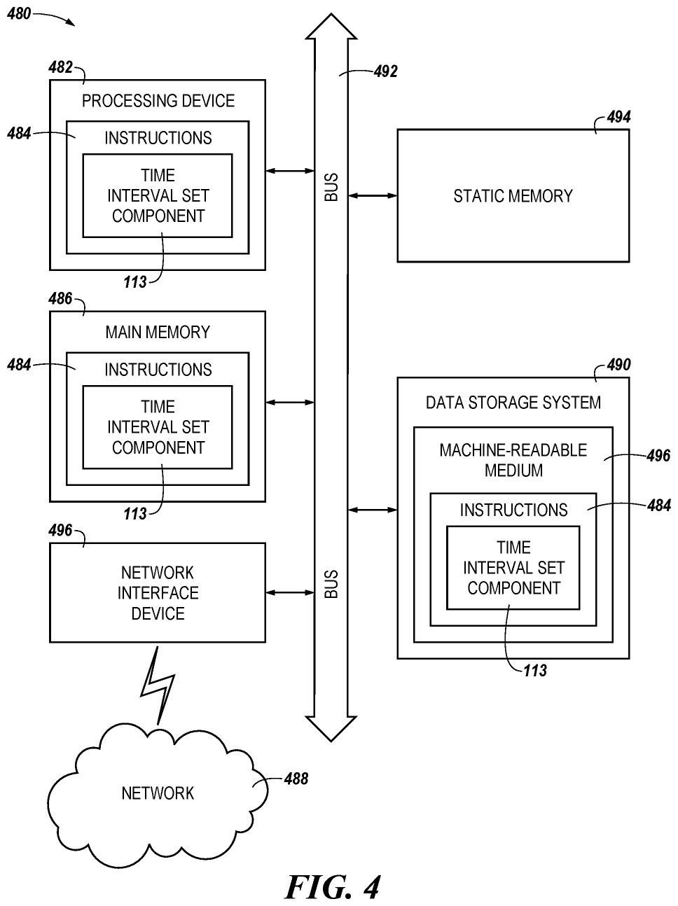

FIG. 4 is a block diagram of an example computer system 480 in which embodiments of the present disclosure can operate. For example, FIG. 4 illustrates an example machine of a computer system 480 within which a set of instructions, for causing the machine to perform any one or more of the methodologies discussed herein, can be executed. In some embodiments, the computer system 480 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the time interval component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 480 includes a processing device 482, a main memory 486 (e.g., read-only memory (ROM), flash memory, dynamic random access memory (DRAM) such as synchronous DRAM (SDRAM) or Rambus DRAM (RDRAM), etc.), a static memory 494 (e.g., flash memory, static random access memory (SRAM), etc.), and a data storage system 490, which communicate with each other via a bus 492.

The processing device 482 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 482 can also be one or more special-purpose processing devices such as an application specific integrated circuit (ASIC), a field programmable gate array (FPGA), a digital signal processor (DSP), network processor, or the like. The processing device 482 is configured to execute instructions 484 for performing the operations and steps discussed herein. The computer system 480 can further include a network interface device 496 to communicate over the network 488.

The data storage system 490 can include a machine-readable storage medium 496 (also known as a computer-readable medium) on which is stored one or more sets of instructions 484 or software embodying any one or more of the methodologies or functions described herein. The instructions 484 can also reside, completely or at least partially, within the main memory 486 and/or within the processing device 482 during execution thereof by the computer system 480, the main memory 486 and the processing device 482 also constituting machine-readable storage media. The machine-readable storage medium 496, data storage system 490, and/or main memory 486 can correspond to the memory sub-system 110 of FIG. 1.

In one embodiment, the instructions 484 include instructions to implement functionality corresponding to a superblock construction component (e.g., the time interval component 113 of FIG. 1). While the machine-readable storage medium 496 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
performing a first memory operation having a first type on a location of a memory component; and
responsive to receiving an access request to perform a second memory operation having a second type on the location, preventing, subsequent to completion of the first memory operation, the second memory operation from being performed for a period of time corresponding to a particular time interval associated with the first type and a second type.

2. The method of claim 1, further comprising allowing the second memory operation to be performed upon expiration of the period of time.

3. The method of claim 1, further comprises, responsive to the second memory operation having the first type instead of the second type, allowing the second memory operation to be performed independently of whether the period of time has expired or not.

4. The method of claim 3, wherein allowing the second memory operation to be performed independently of whether the period of time has expired or not further comprises allowing the second memory operation to be performed within the period of time subsequent to completion of the first memory operation.

5. The method of claim 1, wherein the particular time interval is one of a plurality of time intervals, and wherein the method further comprises:
receiving access requests to perform a plurality of memory operations on the location of the memory component;
determining a respective one of the plurality of time intervals associated with each set of consecutive memory operations of the plurality of memory operations; and
performing the plurality of memory operations with the determined respective one of the plurality of time intervals to prevent a subsequent one of each set of consecutive memory operations from being performed within a respective period of time corresponding to the determined respective one of the plurality of time intervals subsequent to completion of a respective memory operation of the set.

6. The method of claim 5, further comprising performing a set of two consecutive memory operations of the plurality of memory operations independently of the plurality of time intervals responsive to respective types of the consecutive memory operations of the set not corresponding to a respective set of types defined in association with the plurality of time intervals.

7. A system, comprising:
a memory component; and
a processing device, operatively coupled with the memory component, to cause the memory component to:
perform a first memory operation having a first type on a location of the memory component; and
in response to receipt of an access request to perform a second memory operation having a second type:
determine one of a plurality of time intervals associated with the first type and the second type and to be used for the second memory operation; and
prevent, subsequent to completion of the first memory operation, the second memory operation from being performed for a period of time corresponding to the determined one of the plurality of time intervals.

8. The system of claim 7, wherein the processing device is further to cause the memory component to allow the second memory operation to be performed in response to the particular period of time having expired.

9. The system of claim 7, wherein the processing device is further to cause the memory component to allow the second memory operation to be performed independently of the plurality of time intervals in response to the second memory operation having the first type instead of the second type.

10. The system of claim 9, wherein the first memory operation having the first type is an erase operation.

11. The system of claim 7, wherein the plurality of time intervals further comprises:
a first time interval associated with the first memory operation being a program operation and the second memory operation being a read operation;
a second time interval associated with the first memory operation being an erase operation and the second memory operation being a program operation; and
a third time interval associated with the first memory operation being a program operation and the second memory operation being an erase operation.

12. The system of claim 7, wherein periods of time corresponding to at least two of the plurality of time intervals are different.

13. The system of claim 7, wherein the processing device is further to cause the memory component to perform the second memory operation independently of the plurality of time intervals in response to the first and the second types of the first and the second memory operations not corresponding to a respective set of types defined in association with the plurality of time intervals.

14. The system of claim 7, wherein the memory component comprises an array of NAND memory cells and the location corresponds to a block of the array.

15. The system of claim 7, wherein the memory component comprises an array of NAND memory cells and the location corresponds to a page of the array.

16. A non-transitory computer-readable storage medium comprising instructions that, when executed by a processing device, cause the processing device to:
perform a first memory operation having a first type on a location of a memory component;
receive an access request to perform a second memory operation having a second type on the location of the memory component;
in response to a second memory operation having a second type:
determine one of a plurality of time intervals associated with the first type and the second type; and
allow the second memory operation to be performed on the location in response to a period of time corresponding to the determined one of the plurality of time intervals having expired subsequent to completion of the first memory operation; and
in response to the second memory operation having the first type, allow the second memory operation to be performed independently of respective periods of time corresponding to the plurality of time intervals.

17. The non-transitory computer-readable storage medium of claim 16, wherein the processing device is further to prevent, subsequent to completion of the first memory operation, the second memory operation from being performed on the location for the period of time in response to the second memory operation having the second type.

18. The non-transitory computer-readable storage medium of claim 16, wherein a memory operation having the first type corresponds to a program operation or an erase operation.

19. The non-transitory computer-readable storage medium of claim 16, wherein a memory operation having the second type corresponds to a program operation, an erase operation, or a read operation.

20. The non-transitory computer-readable storage medium of claim 16, wherein the processing device is further to allow the second memory operation to be performed within the period of time subsequent to completion of the first memory operation in response to the second memory operation having the first type.
